(19) United States
(12) Patent Application Publication
(10) Pub. No.: US 2015/0336306 A1
(43) Pub. Date: Nov. 26, 2015

(54) METHOD FOR PRODUCING FLEXIBLE MOULDED PU FOAMS

(71) Applicant: Bayer MaterialScience AG, Monheim Am Rhein (DE)

(72) Inventors: Norbert HAHN, Rommerskirchen (DE); Sven MEYER-AHRENS, Leverkusen (DE); Gundolf JACOBS, Rösrath (DE); Dirk LOEHR, Pulheim (DE); Dietmar CZYLWIK, Leichlingen (DE)

(21) Appl. No.: 14/646,510

(22) PCT Filed: Nov. 18, 2013
(86) PCT No.: PCT/EP2013/074013

§ 371 Date: May 21, 2015

(30) Foreign Application Priority Data
Nov. 23, 2012 (EP) 12193978.9

(51) Int. Cl. B29C 44/04; B32B 7/02; C08J 9/00; C08G 18/48; C08G 18/76; B32B 5/32; C08G 18/08

(52) U.S. Cl. CPC B29C 44/04; B32B 5/32; B32B 7/02; C08G 18/14; C08G 18/4804; C08G 18/7671; C08G 18/7664; C08J 9/0061; B32B 2266/0278; B32B 2250/02; B32B 2250/22; C08G 2101/0008

(57) ABSTRACT

The invention relates to a method for producing flexible moulded polyurethane foams (flexible moulded PU foams) with horizontally disposed zones of different hardness, the method being implemented in such a way that at least two fluid reaction mixtures, forming foams with different hardnesses, are introduced in succession in horizontal disposition, in layer form, into the moulding cavity, with at least one fluid reaction mixture being freely foamed, before at least one further foam-forming fluid reaction mixture is introduced into the moulding cavity.

The invention relates to a method for producing molded flexible polyurethane foams (molded flexible PU foams) having horizontally arranged zones with different hardnesses which is carried out by importing two or more flowable reaction mixtures forming foams of differing hardness into the mold cavity in succession in a horizontal layered arrangement, wherein at least one flowable reaction mixture is free-foamed before at least one further foam-forming flowable reaction mixture is imported into the cavity.

DE-A 10016350 discloses a two-zoned foamed part and also a method for producing a two-zoned foamed part. It is preferable for a network of polyethylene, jute, gauze, fibrous nonwoven web or the like to be disposed in a horizontal plane between the foamed part's first region (flexible foam) and its second region (rigid foam). The two regions are separated by the network, the form of the network determining the second region. However, the separation between flexible foam and rigid foam can be situated in the central region of a seat cushion but similarly also in both the central and the side region. The disadvantage with this method is the need to use a separating layer between the different zones, and reproducibility is in need of improvement.

U.S. Pat. No. 6,787,078 discloses a method for producing multizoned foam parts wherein a first elastomeric-forming formulation is introduced into a mold, then a release agent is applied to this elastomeric layer and then a second foam-forming formulation is introduced into the mold and, after full curing, the molded part is demolded. The upper elastomeric layer is adhered to the lower foam layer in the desired areas only, where no release agent was applied. One disadvantage with this method is that the release agent has to be applied in the right places. The elastomeric forming layer is a coating for achieving special haptic properties, for example a leather-like surface. The elastomeric layer also fails to meet comfort requirements in the seating sector, since it is not flexibly resilient like a foamed material.

EP-A 342352 discloses a method for producing foamed cushions having zones of differing hardness by foam molding wherein two or more flowable reaction mixtures capable of forming foamed materials of differing hardness are imported in succession into the mold cavity subject to the proviso that the second reaction mixture is already in an incipiently creamed state at importation, and the foamed cushion is demolded after curing. The first still liquid reaction mixture is applied via a perforate sheet body. Two zones differing in hardness can thus be arranged one on top of the other, i.e., horizontally. Disadvantages with this method are the need to import the perforate sheet body and the need to import the second reaction mixture in an incipiently creamed state. Reproducibility is in need of improvement.

EP-A 0370750 discloses water-blown molded flexible polyurethane foam for car seats which has two layers of differing hardness. Both the first flexible polyurethane foam formulation and the second flexible polyurethane foam formulation are foamed in the closed mold. The disadvantage with this method is the poor reproducibility of the resulting parts on the manufacturing scale.

U.S. Pat. No. 6,419,863 discloses molded flexible polyurethane foam for car seats which has two horizontal layers of differing hardness. The first layer is imported into the mold as a spray foam and free-foamed, the second foam formulation is imported into the mold and expanded with the mold closed. The disadvantage with this method is the large amount of time required on the manufacturing scale, since the spray foam has to be applied quickly in several superposed layers.

Existing methods for producing molded flexible polyurethane foams having horizontally arranged zones with different hardnesses use specific separating layers to establish the horizontally arranged zones with different hardnesses in the molded parts. In practice, however, the reproducibility of these methods is poor, which has adverse implications for mass production in particular. Desired properties such as, for example, lateral support cornering in the case of cushioned seats, for example, or particularly soft seating areas can accordingly not come to fruition.

The problem addressed by the present invention was therefore that of improving the method for producing molded flexible polyurethane foams having horizontally arranged zones of differing hardness with regard to their reproducibility of the exact position and extensions of the individual zones in the final molded flexible foam and also the properties of the individual zones.

The problem was solved by performing the method for producing molded flexible polyurethane foams (molded flexible PU foams) having horizontally arranged zones with different hardnesses by importing two or more flowable reaction mixtures forming foams of differing hardness into the mold cavity in succession in a horizontal layered arrangement, wherein at least one flowable reaction mixture is free-foamed before at least one further foam-forming flowable reaction mixture is imported into the cavity.

Free-foamed is to be understood as meaning that the foam-forming reaction mixture is able to expand against the ambient pressure without mechanical restriction in the direction of rise.

Molded flexible PU foams having horizontally arranged zones with different hardnesses are an arrangement of the different layers essentially parallel to the outermost seat or backrest layer and/or parallel to the plan view on the foam.

The present invention accordingly provides a method for producing molded flexible polyurethane (PU) foams having horizontally arranged zones of differing hardness, characterized in that in step
1) a flowable reaction mixture I is imported into the mold cavity and free-foamed, 2) from 1 to 6 min, preferably 2 to 5 min, more preferably 3 to 4 min, after importing said reaction mixture I into the mold cavity at least one flowable reaction mixture II is imported into the mold cavity,
3) curing in the mold, and
4) demolding the molded flexible PU foam formed after step 3,
wherein said flowable reaction mixture I forms a flexible PU foam having an apparent density of 30 to 90 kg/m³, preferably 40 to 85 kg/m³, and said flexible reaction mixture II forms a molded flexible PU foam having an apparent density of 30 to 85 kg/m³, preferably 40 to 80 kg/m³.

A plurality of reaction mixtures II, for example 11.1, 11.2, 11.3, 11.4, etc., are also importable in succession into the mold cavity in step 2), depending on the requirements of the foamed article to be produced, in that said reactions mixtures II.1, II.2, II.3, II.4, etc., merely differ in the compression load deflection of the molded flexible PU foam they give rise to. The different compression load deflection values of reaction mixtures II are attained through different isocyanate indices for reaction mixtures II.1, II.2, II.3, II.4, etc., and/or by varying the polyol formulation. At least one of reaction mixtures II.1, II.2, II.3, II.4, etc., is in a horizontal arrangement relative to the flexible PU free-foamed in step 1).

The present invention further also provides the molded flexible PU foams obtained by the method of the present invention and for their used in the manufacture of moldings and also the moldings themselves.

The components of reaction mixtures I and II in steps 1 and 2 of the method according to the present invention are made to react by the one-shot process, which is known per se, the prepolymer process or the semi-prepolymer process, often by using mechanical means, for example those described in EP-A 355 000. Details of processing means which are also useful for the purposes of the present invention are described in Kunststoff-Handbuch, volume VII, edited by Vieweg and Höchtlen, Carl-Hanser-Verlag, Munich 1993, for example at pages 139 to 265. Mixing the components of reaction mixtures I and II, respectively, initiates the polymerization and expansion of the polymerizing material. Polymerization and shaping often take place in one step, typically by shaping or spraying the reaction mixture while it is still in the liquid state. Molded foams are also obtainable by hot or else cold curing.

The abovementioned components of reaction mixtures I and II comprise, firstly, a polyfunctional organic isocyanate component (often also referred to as “B-component”) and, secondly, polyfunctional monomers or resins which are isocyanate-reactive and may optionally contain further, auxiliary materials. This mixture, which is frequently referred to as “A-component”, typically is very largely composed of one or more polyol components.

If, then, a molded flexible PU foam of defined composition is to be obtained, the components described above are appropriately dosed before they are mixed. An expansion effect is normally achieved in the process by admixing the A-component with water, which reacts with the polyisocyanate of the B-component to form an amine and release CO₂, which in turn functions as a blowing gas. Alternatively or additionally to the use of water, volatile inert organic compounds or inert gases are often also used.

The mold cavities used in the method of the present invention reflect the structure of the foamed article desired. The PU foams obtainable by the method according to the present invention are used, for example, for furniture cushioning, textile insert, mattresses, automotive seats, headrests, armrests, sponges and component elements, and also seat and dashboard trim, preferably for furniture cushioning, textile inserts, mattresses, automotive seats and headrests.

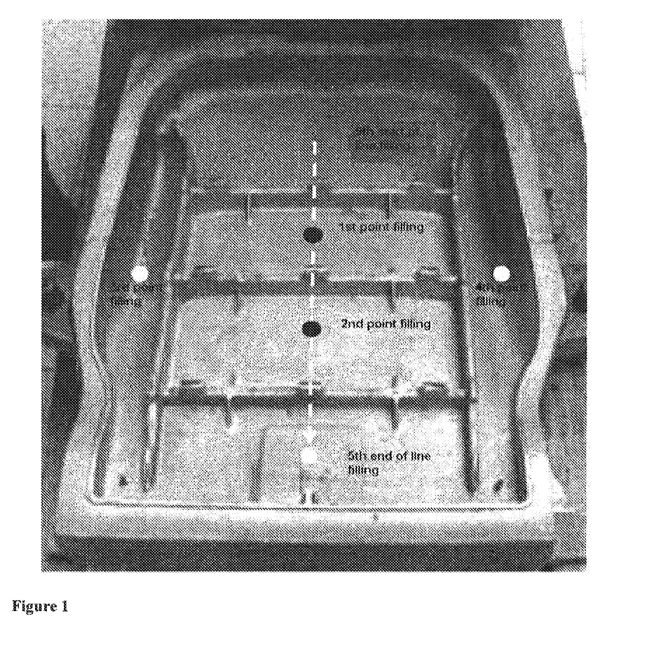

The mold cavities to be used may be subdivided by ridges into separate regions in order that different flowable reaction mixtures may be imported into the mold cavity. The mold cavities used in the process of the present invention are preferably subdivided by ridges into separate regions (FIG. 1) in order to obtain, in the mold cavity to be produced, regions of differing hardness at predetermined positions. FIG. 1 shows a mold cavity which represents a sitting surface for a car seat for example. The floor area of the mold cavity represents the surface of the resulting seat after the molded foam has been produced. It is thus possible, for instance, with reference to FIG. 1, for the central region to have imported into it (1^{st} and 2^{nd} point fillings) a reaction mixture I which gives rise to a soft foam, for the side regions to have imported into them (3rd and 4^{th} point fillings) a reaction mixture II.1 which gives rise to a hard foam, and thus provides a high level of seat support, and for the outer zones of the sitting area to have imported into them (5^{th} line filling) a further reaction mixture II.2 which gives rise to a harder foam than in the central sitting area and a softer foam than in the side portions.

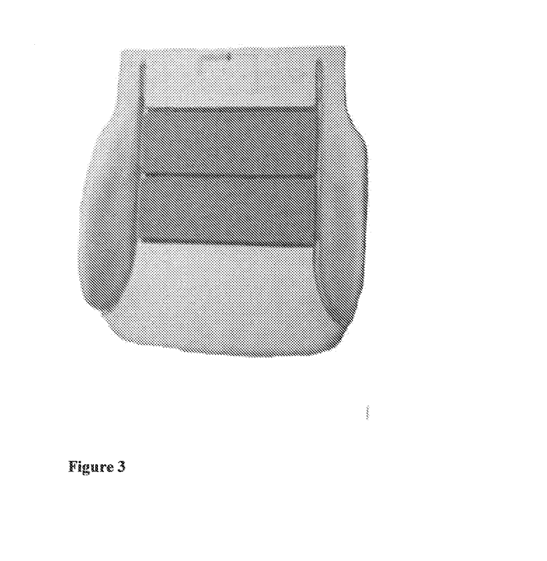

The method of the present invention comprises a first step whereby, in procedures known to a person skilled in the art, a flowable reaction mixture I is imported into the mold cavity at the desired position and then free-foamed. Preferably, the starting components of reaction mixture I are one-shot processed and imported into the mold at the desired position. It is thus possible for instance, referring to FIG. 1, for reaction mixture I to be introduced into the central region (1^{st} and 2^{nd} point fillings) and free-foamed therein. This region gives rise in the end product to the central sitting area of the foamed article (FIG. 3).

The flowable reaction mixture I contains the components

component I-A1
I-A1.1 at least one polyether polyol having a functionality of 2 to 8, preferably of 2 to 6, more preferably of 2 to 4, a DIN 53240 OH number in the range from 20 to 70 mg KOH/g and a polyoxypropylene (PO) content in the range from 50 to 100 wt % and a polyoxyethylene (EO) content in the range from 0 to 50 wt %,
I-A.1.2 optionally at least one polyether polyol having a hydroxyl functionality of 2 to 8, preferably of 2 to 6, more preferably of 2, a DIN 53240 hydroyl (OH) number in the range from 50 to 65 mg KOH/g and a PO content in the range 45 to 55 wt % and an EO content in the range from 45 to 55 wt %;
I-A1.3 optionally at least one dispersion of a polymer in a polyether polyol, wherein the dispersion has a DIN 53240 OH number in the range from 10 to 30 mg KOH/g and wherein the polyether polyol has a hydroxyl functionality of 2 to 6, preferably of 2 to 4, more preferably of 3, a PO content in the range from 70 to 90 wt % and an EO content in the range from 10 to 30 wt %;
I-A1.4 optionally at least one polyether polyol having a functionality of 2 to 8, preferably of 2 to 6, more preferably of 3, an OH number in the range from 220 to 290 mg KOH/g and a PO content of up to 25 wt % and an EO content of at least 75 wt %;
A2 water and/or a physical blowing agent,
A3 optionally isocyanate-reactive hydrogen compounds having an OH number of 140 mg KOH/g to 900 mg KOH/g,
A4 auxiliary and added-substance materials such as
   a) catalysts,
   b) surface-active added-substance materials, and,
   c) pigments or flame retardants, and

component B:
di- and/or polyisocyanates, preferably aromatic polyisocyanates,

wherein the foam is produced at an isocyanate index of 70 to 130, preferably of 80 to 115, more preferably of 85 to 95.

Preferably, the proportional parts by mass of components I-A 0.1 to I-A1.4 (independently of each other, where applicable) are in the following ranges: from 10 to 100 parts by weight in the case of I-A1.1; from 0 to 70 parts by weight in the case of I-A1.2; from 0 to 40 parts by weight in the case of I-A1.3 and from 0 to 25 parts by weight in the case of I-A1.4. The proportional parts by mass of components I-A1.1 to I-A1.4 add up to 100.

The proportional parts by mass of components A2 to A4 are preferably in the following ranges: from 0.5 to 25 parts by weight and preferably from 2 to 5 parts by weight in the case of A2, from 0 to 10 parts by weight and preferably from 0 to 5 parts by weight in the case of A3 and from 0.05 to 10 parts by weight and preferably from 0.2 to 5 parts by weight in the case of A4, while the parts by weight of components A2 to A4 are based on total component I-A1.

One embodiment of the method according to the present invention utilizes a flowable reaction mixture I which gives rise to a viscoelastic foam having a DIN EN ISO 3386-1-98 apparent density of 30 to 90 kg/m³, preferably 40 to 85 kg/m³, and also a DIN EN ISO 3386-1-98 compression load deflection of 2.0 to 4.0 kPa, preferably of 2.3 to 3.5 kPa. It is particularly preferable to use a viscoelastic foam where the mechanical properties (e.g., hardness, hysteresis) are minimally dependent on the temperature.

Viscoelastic foams are notable for their slow, gradual recovery from compression. This manifests, for example, in a high hysteresis (>20%; in pressure-tension curves when determining the indentation hardness to DIN EN ISO 2439 or the compression load deflection to DIN EN ISO 3386-1-98) or in a low ball rebound resilience (<15%; as determined to DIN EN ISO 8307).

One embodiment of the method according to the present invention, flowable reaction mixture I utilizes component I-A1.1 in an amount of 10 to 40 parts by weight, component I-A1.2 in an amount of 30 to 70 parts by weight, component I-A 1.3 in an amount of 5 to 40 parts by weight and component I-A 1.4 in an amount of 5 to 25 parts by weight, wherein the proportional parts by mass of components I-A1.1 to I-A1.4 100 add up to 100. These proportional parts by weight are preferable since they result in a particularly low temperature dependence of the physical properties in the polyurethane foam of the present invention.

The isocyanate index (i.e., the index) indicates the ratio of the isocyanate quantity actually used to the stoichiometric, i.e., computed, quantity of isocyanate (NCO):

Isocyanate index=[(isocyanate quantity used):(isocyanate quantity computed)]*100 (1)

In the method of the present invention, step I provides that reaction mixture I imported into the mold cavity be foamed as a free-rise foam in the closed or opened mold cavity.

After a period of 1 to 6 min, preferably 2 to 5 min, more preferably 3 to 4 min, reckoned from the importation of reaction mixture I, the surface of the foam which has formed is still tacky and flowable reaction mixture II is imported into the mold as per step 2. Flowable reaction mixture II is imported into the mold cavity such that it gives rise to a molded foam arranged horizontally in relation to previously foamed reaction mixture I. The resulting foamed articles have two zones of differing hardness in a horizontal (i.e., parallel) arrangement and are so-called “Horizontal Dual Htardness” articles.

Flowable reaction mixture II gives rise to a molded foam having a DIN EN ISO 3386-1-98 apparent density of 30 to 85 kg/m³, preferably 40 to 80 kg/m³, and also a DIN EN ISO 3386-1-98 compression load deflection of 3.0 to 14.0 kPa, preferably of 3.5 to 12.0 kPa.

One embodiment of the method according to the present invention produces a molded foam having three arranged zones of differing hardness, so-called “triple hardness” articles. For this, step 2 of the method according to the present invention provides that after I to 6 min, preferably 2 to 5 min, more preferably 3 to 4 min, reckoned from importation of reaction mixture 1, first a flowable reaction mixture II.1 (step 2a) and directly thereafter a reaction mixture II.2 (step 2b) be imported into the mold cavity, that reaction mixtures II.1 and II.2 give rise to molded foams of differing hardness and that reaction mixture II.2 be in a horizontal (parallel) arrangement relative to I.

In this embodiment, flowable reaction mixture II.1 gives rise to a molded foam having a DIN EN ISO 3386-1-98 apparent density of 30 to 85 kg/m³, preferably 40 to 80 kg/m³ and a DIN EN ISO 3386-1-98 compression load deflection of 6.0 to 14.0 kPa, preferably of 8.0 to 12.0 kPa, and is imported into the mold cavity at the desired position, for example in the side regions as per FIG. 1 (3^{rd} and 4^{th} point fillings).

Flowable reaction mixture II.2 is imported into the mold cavity directly after the importation of flowable reaction mixture II.1 and at the desired position, for example in the forward or rearward seat region of FIG. 1 (5^{th} line filling), to give rise to a foam which is formed in a horizontal arrangement relative to the resulting foam of reaction mixture I. Preferably, reaction mixture II.2 gives rise to a molded foam having a DIN EN ISO 3386-1-98 apparent density of 30 to 85 kg/m³, preferably 40 to 80 kg/m³, and also a DIN EN ISO 3386-1-98 compression load deflection of 3.0 to 9.0 kPa, preferably of 3.5 to 8.0 kPa.

Reaction mixtures II.1 and II.2, which are imported into the mold cavity in step 2, differ only in their compression load deflection, which is set via the isocyanate index and/or in the chemical composition.

Flowable reaction mixture II preferably contains the components
component II-A 1
   II-A1.1 at least one polyether polyol having a functionality of 2 to 8, preferably of 2 to 6, more preferably 3 to 4, a polyoxyethylene (EO) content of 0 to 30 wt %, preferably of 0 to 20 wt %, a DIN 53240 OH number of ≧10 mg KOH/g to ≦112 mg KOH/g, preferably of 20 mg KOH/g to ≦40 mg KOH/g,
   II-A 1.2 optionally at least one polyether polyol having a functionality of 2 to 8, preferably of 2 to 6, more preferably of 3, a polyoxyethylene (EO) content of >60 wt %, preferably >70 wt %, a DIN 53240 OH number of ≧10 mg KOH/g to ≦112 mg KOH/g, preferably of ≧20 mg KOH/g to ≦50 mg KOH/g,
   II-A 1.3 optionally at least one dispersion of a polymer in a polyether polyol, wherein the dispersion has a DIN 53240 OH number in the range from 10 to 60 mg KOH/g and wherein the polyether polyol has a hydroxyl functionality of 2 to 6, preferably of 2 to 4, more preferably of 3, a polyoxypropylene (PO) content in the range from 70 to 90 wt % and an EO content in the range from 10 to 30 wt %;
A2 water and/or physical blowing agents,
A3 optionally isocyanate-reactive hydrogen compounds having an OH number of 140 mg KOH/g to 900 mg KOH/g,
A4 auxiliary and added-substance materials such as
   a) catalysts,
   b) surface-active added-substance materials,
   c) pigments or flame retardants, and
B di- or polyisocyanates, preferably aromatic polyisocyanates,
wherein the flexible polyurethane foam is produced at an isocyanate index of 75 to 120.

The proportional parts by mass of components II-A1.1 to II-A1.3 (independently of each other, where applicable) can be in the following ranges: from 10 to 100 parts by weight of II-A1.1; from 0 to 10 parts by weight of II-A1.2; from 0 to 90 parts by weight in the case of II-A 1.3, wherein the parts by weigh of II-A 1.1 to II-A1.3 add up to 100, from 0.5 to 25 parts by weight and preferably from 2 to 5 parts by weight in the case of A2; from 0 to 10 parts by weight and preferably from 0 to 5 parts by weight in the case of A3 and from 0.05 to 10 parts by weight and preferably from 0.2 to 4 parts by weight in the case of A4, wherein the parts by weight of components A2 to A4 are based on total component II-A1.

Flowable reaction mixtures II.1 and II.2 are employed in a further embodiment of the method according to the present invention. In this embodiment, the proportional parts by mass of the components are in the following ranges: from 90 to 100 parts by weight in the case of II-A1.1, from 0 to 10 parts by weight in the case of II-A1.2, the parts by weight of II-A1.1 to II-A1.2 adding up to 100, from 0.5 to 25 parts by weight and preferably from 2 to 5 parts by weight in the case of A2, from 0 to 10 parts by weight and preferably from 0 to 5 parts by weight in the case of A3 and from 0.05 to 10 parts by weight and preferably from 0.2 to 4 parts by weight in the case of A4, the parts by weight of components A2 to A4 being based on total component II-A1.1 to II-A1.2. In this embodiment, reaction mixture II.1 is foamed at an isocyanate index of 95 to 120, preferably of 100 to 115, while reaction mixture II.2 is foamed at an isocyanate index of 75 to 95, preferably of 80 to 90. In this embodiment, component B preferably contains one or more aromatic polyisocyanates, more preferably aromatic polyisocyanates based on polyphenyl polymethylene (MDI).

After the importation of reaction mixture II in step 2, although it is also possible for a plurality of reaction mixtures II, for examples II.1 and II.2, to be imported in succession into the mold cavity in step 2, the foam is cured in the mold (step 3). Following a period of 3 to 8 min, preferably 4 to 6 min, reckoned from completed importation of reaction mixture in step 2, the molding is demolded (step 4) and subjected to mechanical flexing (in a roller or vacuum crusher) to burst open its closed cells.

The individual components included in reaction mixtures I and II will now be more particularly described.

Component I-A1

Polyol component I-A1 contains components I-A1.1 to I-A1.4. The compounds of polyol components I-A1.1 to I-A1.4 are prepared by addition of alkylene oxides onto starter compounds having isocyanate-reactive hydrogen atoms. These starter compounds usually have functionalities of 2 to 8, preferably of 2 to 6, more preferably of 2 to 4, and are preferably hydroxyl functional. Examples of hydroxyl-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene, methylolyl-containing condensates of formaldehyde and phenol or melamine or urea. The starter compound used is preferably glycerol and/or trimethylolpropane.

Suitable alkylene oxides include, for example, ethylene oxide, propylene oxide, 1,2-butylene oxide/2,3-butylene oxide and styrene oxide. It is preferable for propylene oxide and ethylene oxide to be introduced into the reaction mixture singly, in admixture or in succession. When the alkylene oxides are added in succession, the products obtained (polyether polyols) contain polyether chains having block structures. Products having ethylene oxide end-blocks are for example characterized by enhanced concentrations of primary end groups, which endow the systems with an advantageous isocyanate reactivity.

It has become customary in the prior art to specificize these polyether polyols in terms of various characteristic parameters:
i.) hydroxyl functionality, which is dependent on the starter molecule from which the polyether polyol is synthesized;
ii.) hydroxyl or OH number, which is a measure of the hydroxyl group content and is reported in mg KOH/g. It is determined as described in DIN 53240;
iii.) the proportion of the polyether polyol which is attributable to epoxides whose ring opening leads to the formation of different (i.e., primary or secondary) hydroxyl groups as well as the proportion of primary/secondary hydroxyl groups in relation to the overall number of hydroxyl groups present in the polyether polyol;
iv.) molecular mass (Mₙ or M_{w}), which is a measure of the length of the polyoxyalkylene chains of polyether polyols.

The abovementioned parameters can be made to relate to each other via the following equation:

56 100=OH number*(M_{W}/hydroxyl functionality).

In a further embodiment, component I-A1 may also utilize polyether carbonate polyols as obtainable for example by catalytic reaction of alkylene oxides (epoxides) and carbon dioxide in the presence of H-functional starter substances (see for instance EP-A 2046861). These polyether carbonate polyols generally have a hydroxyl functionality of at least 1, preferably of 2 to 8, more preferably of 2 to 6 and most preferably of 2 to 4. OH number is preferably ≧3 mg KOH/g to ≦140 mg KOH/g, more preferably ≧10 mg KOH/g to ≦112 mg KOH/g.

Component I-A1.1 contains at least one polyether polyol having a functionality of 2 to 8, preferably of 2 to 6, more preferably of 2 to 4, a DIN 53240 OH number in the range from 20 to 70 mg KOH/g and a polyoxyethylene (PO) content in the range from 50 to 100 wt % and an ethylene oxide (EO) content in the range from 0 to 50 wt %. The proportion of primary hydroxyl groups in component I-A1.1 in relation to the overall number of primary and secondary hydroxyl groups is preferably in the range from 0 to 3%.

Component I-A1.2 contains at least one polyether polyol having a hydroxyl functionality of 2 to 8, preferably of 2 to 6, more preferably of 2, a DIN 53240 hydroxyl (OH) number in the range from 50 to 65 mg KOH/g and a PO content in the range from 45 to 55 wt % and an EO content in the range from 45 to 55 wt %. The proportion of primary hydroxyl groups in I-A1.2 in relation to the overall number of primary and second hydroxyl groups in component I-A1.2 is preferably in the range from 40 to 80%, more preferably in the range from 50 to 70%.

Component I-A1.3 of polyether polyol composition I-A1 according to the present invention is a dispersion of a polymer. Dispersions of this type are known as polymer-modified polyols and include polymer-modified polyether polyols, preferably grafted polyether polyols, in particular those of styrene and/or acrylonitrile basis, which are advantageously obtained by in situ polymerization of styrene, acrylonitrile or preferably of mixtures of styrene and acrylonitrile (for example in a weight ratio of 90:10 to 10:90, in particular from 70:30 to 30:70) in the abovementioned polyether polyols (by methods as described in the following patent documents: DE 11 11 394, DE 12 22 669, DE 11 52 536, DE 11 52 537, U.S. Pat. No. 3,304,273, U.S. Pat. No. 3,383,351, U.S. Pat. No. 3,523,093, GB 1040452, GB 987618).

Dispersions referred to above likewise comprehend polyurea dispersions, which are obtained by reaction of diamines and diisocyanates in the presence of a polyol component (PUD dispersions), and/or urethane group-containing dispersions, which are obtained by reaction of alkanolamines and diisocyanates in a polyol component (PIPA polyols).

The filler-containing polyether polyols of component I-A1.3 (PUD dispersion) are formed for example by in situ polymerization of an isocyanate or of an isocyanate mixture with a diamine and/or hydrazine in a polyol as per component II-A1.2. The PUD dispersion is preferably formed by reacting an isocyanate mixture of 75 to 85 wt % of 2,4-tolylene diisocyanate (2,4-TDI) and 15 to 25 wt % of 2,6-tolylene diisocyanate (2,6-TDI) with a diamine and/or hydrazine. Processes for producing PUD dispersions are described for example in U.S. Pat. No. 4,089,835 and U.S. Pat. No. 4,260,530.

The filler-containing polyether polyols of component I-A1.3 may also be PIPA-modified polyether polyols, i.e., polyether polyols modified with alkanolamines by polyisocyanate polyaddition, the polyether polyol having a functionality of 2.5 to 4 and a molecular weight of 500 to 18 000.

Component I-A1.3 has an OH number of 10 to 30 mg KOH/g, a hydroxyl functionality of 2 to 6, preferably 2 to 4, more preferably 3, a PO content in the range from 70 to 90 wt % and an EO content in the range from 10 to 30 wt %. The proportion of primary hydroxyl groups in I-A1.3 relative to the overall number of primary and secondary hydroxyl groups in component I-A1.3 is preferably in the range from 40 to 95% and more preferably in the range from 50 to 90%.

Component I-A1.4 contains at least one polyether polyol having a functionality of 2 to 8, preferably of 2 to 6, more preferably of 3, an OH number in the range from 220 to 290 mg KOH/g and a PO content of up to 25 wt % and an EO content of at least 75 wt %. The proportion of primary hydroxyl groups in component I-A1.4 in relation to the overall number of primary and secondary hydroxyl groups is preferably at least 90%,

Component II-A1

Components II-A1 are in principle prepared in the same way as components I-A1 by addition of alkylene oxides onto starter compounds having isocyanate-reactive hydrogen atoms. These starter compounds usually have functionalities of 2 to 8, preferably of 2 to 6, more preferably of 2 to 4, and are preferably hydroxyl functional. Examples of hydroxyl-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol F, bisphenol A, 1,3,5-trihydroxybenzene, methylolyl-containing condensates of formaldehyde and phenol or melamine or urea. The starter compound used is preferably glycerol and/or trimethylolpropane.

Suitable alkylene oxides include, for example, ethylene oxide, propylene oxide, 1,2-butylene oxide/2,3-butylene oxide and styrene oxide. It is preferable for propylene oxide and ethylene oxide to be introduced into the reaction mixture singly, in admixture or in succession. When the alkylene oxides are added in succession, the products obtained contain polyether chains having block structures. Products having ethylene oxide end-blocks are for example characterized by enhanced concentrations of primary end groups, which endow the systems with an advantageous isocyanate reactivity.

Starting components as per component II-A1 are compounds having at least two isocyanate-reactive hydrogen atoms and generally a molecular weight of 400-18 000. These compounds include not only amino-, thio- or carboxyl-containing compounds but preferably hydroxyl-containing compounds, in particular compounds having from 2 to 8 hydroxyl groups, specifically those with a molecular weight within the range from 1000 to 6000, preferably in the range from 2000 to 6000, e.g., the polyethers, polyesters, polycarbonates and polyester amides with at least 2, generally 2 to 8, but preferably 2 to 6, hydroxyl groups, which are known per se for the production of homogeneous and of cellular polyurethanes and are described for example in EP-A 0 007 502, pages 8-15. Polyether polyols with at least two hydroxyl groups are preferable for the purposes of the present invention. Said polyether polyols are preferably prepared by addition of alkylene oxides (such as, for example, ethylene oxide, propylene oxide and butylenes oxide or mixtures thereof) onto starters such as ethylene glycol, propylene glycol, glycerol, trimethylolpropane, pentaerythritol, sorbitol, mannitol and/or sucrose, so a functionality between 2 and 8, preferably between 2.5 and 6 and more preferably between 2.5 and 4 can be established.

Component II-A1.1 preferably includes at least one polyether polyol having a functionality of 2 to 8, preferably of 2 to 6, more preferably of 3 to 4, an EO content of 0 to 30 wt %, preferably of 0 to 20 wt %, and a DIN 53240 OH numbers of ≧10 to ≦112 mg KOH/g, preferably ≧20 to ≦40 mg KOH/g. The proportion of primary hydroxyl groups in II-A1.1 in relation to the overall number of primary and secondary hydroxyl groups in component II-A1.1 is preferably in the range from 40 to 95%, more preferably in the range from 50 to 90%.

Component II-A1.2 preferably includes at least one polyether polyol having a functionality of 2 to 8, preferably of 2 to 6, more preferably of 3, an EO content >60 wt %, preferably >70 wt %, and a DIN 53240 OH number of 10 to 112 mg KOH/g, preferably 20 to 50 mg KOH/g. The proportion of primary hydroxyl groups in II-A1.2 in relation to the overall number of primary and secondary hydroxyl groups in component II-A1.2 is preferably in the range from 40 to 95%, more preferably in the range from 50 to 90%.

Component II-A1.3 of polyether polyol composition II-A1 according to the present invention is a dispersion of a polymer. Dispersions of this type are known as polymer-modified polyols and include polymer-modified polyether polyols, preferably grafted polyether polyols, in particular those of styrene and/or acrylonitrile basis, which are advantageously obtained by in situ polymerization of styrene, acrylonitrile or preferably of mixtures of styrene and acrylonitrile (for example in a weight ratio of 90:10 to 10:90, in particular from 70:30 to 30:70) in the abovementioned polyether polyols (by methods as described in the following patent documents: DE 11 11 394, DE 12 22 669, DE 11 52 536, DE 11 52 537, U.S. Pat. No. 3,304,273, U.S. Pat. No. 3,383,351, U.S. Pat. No. 3,523,093, GB 1040452, GB 987618).

Dispersions referred to above likewise comprehend those which by polyurea dispersion, which are obtained by reaction of diamines and diisocyanates in the presence of a polyol component (PUD dispersions), and/or urethane group-containing dispersions, which are obtained by reaction of alkanolamines and diisocyanates in a polyol component (PIPA polyols).

The filler-containing polyether polyols of component II-A1.3 (PUD dispersion) are formed for example by in situ polymerization of an isocyanate or of an isocyanate mixture with a diamine and/or hydrazine in a polyol as per component II-A1.2. The PUD dispersion is preferably formed by reacting an isocyanate mixture used of a mixture of 75 to 85 wt % of 2,4-tolylene diisocyanate (2,4-TDI) and 15 to 25 wt % of 2,6-tolylene diisocyanate (2,6-TDI) with a diamine and/or hydrazine. Processes for producing PUD dispersions are described for example in U.S. Pat. No. 4,089,835 and U.S. Pat. No. 4,260,530.

The filler-containing polyether polyols of component II-A1.3 may also be PIPA-modified polyether polyols, i.e., polyether polyols modified with alkanolamines by polyisocyanate polyaddition, the polyether polyol having a functionality of 2.5 to 4 and a molecular weight of 500 to 18 000.

Compounds of component II-A1.3 have a DIN 53240 OH number of 10 to 60 mg KOH/g, a hydroxyl functionality of 2 to 6, preferably 2 to 4, more preferably 3, a PO content in the range from 70 to 90 wt % and an EO content in the range from 10 to 30 wt %.

Component A2

Component A2 comprises water and/or physical blowing agents. Useful physical blowing agents include, for example, carbon dioxide and/or volatile organics such as, for example, dichloromethane being used as blowing agents.

Component A3

Component A3, the use of which is optional, comprises compounds having at least two isocyanate-reactive hydrogen atoms and an OH number of 140 mg KOH/g to 900 mg KOH/g. This is to be understood as meaning compounds having hydroxyl groups and/or amino groups and/or thiol groups and/or carboxyl groups, preferably hydroxyl- and/or amino-containing compounds used as extenders or crosslinkers. The number of isocyanate-reactive hydrogen atoms in these compounds is generally in the range from 2 to 8, preferably in the range from 2 to 4. Ethanolamine, diethanolamine, triethanolamine, sorbitol and/or glycerol, for example, are useful as component A4. Further examples of compounds useful as component A4 are described in EP-A 0 007 502, pages 16-17.

Component A4

Component A4 comprises auxiliary and added-substance materials such as
a) catalysts (activators),
b) surface-active added-substance materials (surfactants), such as emulsifiers and foam stabilizers especially those of low emission such as, for example, products of the Tegostab® LF series,
c) additives such as reaction retarders (e.g., acidic materials such as hydrochloric acid or organic acyl halides), cell regulators (such as, for example, paraffins or fatty alcohols or dimethylpolysiloxanes), pigments, dyes, flame retardants (such as, for example, tricresyl phosphate), stabilizers against aging and weathering effects, plasticizers, fungistats, bacteriostats, fillers (such as, for example, barium sulfate, kieselguhr, carbon black chalk or precipitated chalk) and release agents.

These auxiliary and added-substance materials, the use of which is optional, are described for example in EP-A 0 000 389, pages 18-21. Further examples of auxiliary and added-substance materials for optional use in the present invention and also details as to ways these auxiliary and added-substance materials are used and function are described in Kunststoff-Handbuch, volume VII, edited by G. Oertel, Carl-Hanser-Verlag, Munich, 3^{rd} edition, 1993, for example on pages 104-127.

Preferred catalysts are aliphatic tertiary amines (for example trimethylamine, tetramethylbutanediamine), 3-dimethylaminopropylamine, N,N-bis(3-dimethyl-aminopropyl)-N-isopropanolamine, cycloaliphatic tertiary amines (for example 1,4-diaza(2,2,2)bicyclooctane), aliphatic aminoethers (for example bisdimethylaminoethyl ether 2-(2-dimethylaminoethoxyl)ethanol and N,N,N-trimethyl-N-hydroxyethylbisaminoethyl ether), cycloaliphatic aminoethers (for example N-ethylmorpholine), aliphatic amidines, cycloaliphatic amidines, urea and derivatives of urea (such as, for example, aminoalkylureas, see for instance EP-A 0 176 013, in particular (3-dimethylaminopropylamine)urea) and tin catalysts (such as, for example, dibutyltin oxide, dibutyltin dilaurate, tin octoate).

Component B

Component B comprises aliphatic, cycloaliphatic, araliphatic, aromatic and heterocyclic di- or polyisocyanates as described for example by W. Siefken in Justus Liebigs Annalen der Chemie, 562, pages 75 to 136, for example those of formula (I)

Q(NCO)ₙ (1)

where
n is =2-4, preferably 2-3, and
Q is an aliphatic hydrocarbon moiety of 2-18, preferably 6-10 carbon atoms, a cycloaliphatic hydrocarbon moiety of 4-15, preferably 6-13 carbon atoms or an araliphatic hydrocarbon moiety of 8-15, preferably 8-13 carbon atoms.

Polyisocyanates as described in EP-A 0 007 502, pages 7-8, are concerned, for example. Preference is generally given to polyisocyanates that are readily available industrially, for example 2,4- and 2,6-tolylene diisocyanates, and also any desired mixtures of these isomers (“TDI”); to polyphenyl polymethylene polyisocyanates as obtained by aniline-formaldehyde condensation and subsequent phosgenation (“crude MDI”) and to polyisocyanates containing carbodiimide groups, urethane groups, allophanate groups, isocyanurate groups, urea groups or biuret groups (“modified polyisocyanates”), in particular to such modified polyisocyanates as derive from 2,4- and/or 2,6-tolylene diisocyanate and/or from 4,4′- and/or 2,4′-diphenylmethane diisocyanate. The polyisocyanate used is preferably at least one compound selected from the group consisting of 2,4- and 2,6-tolylene diisocyanates, 4,4′- and 2,4′- and 2,2′-diphenylmethane diisocyanate and polyphenyl polymethylene polyisocyanate (“polynuclear MDI”).

In one embodiment according to the present invention, the polyisocyanate employed in reaction mixture I is preferably 4,4′- and 2,4′- and 2,2′-diphenylmethane diisocyanate and polyphenyl polymethylene polyisocyanate (“polynuclear MDI”) and also mixtures thereof and the polyisocyanate employed in reaction mixture II is at least one compound selected from the group consisting of 2,4- and 2,6-tolylene diisocyanate, 4,4′- and 2,4′- and 2,2′-diphenylmethane diisocyanate and polyphenyl polymethylene polyisocyanate (“polynuclear MDI”) and also mixtures thereof.

In one further embodiment according to the present invention, the polyisocyanate employed in reaction mixture I is preferably 4,4′- and 2,4′- and 2,2′-diphenylmethane diisocyanate and polyphenyl polymethylene polyisocyanate (“polynuclear MDI”) and also mixtures thereof and the polyisocyanate employed in reaction mixture II is preferably 4,4′- and 2,4′- and 2,2′-diphenylmethane diisocyanate and polyphenyl polymethylene polyisocyanate (“polynuclear MDI”).

The method of the present invention is notable for very good reproducibility of the position of the horizontally arranged zones of differing hardness in the molded flexible PU foam articles obtained according to the present invention. The method of the present invention further makes it possible to produce molded foam articles having several zones of differing hardness, wherein at least two of the zones of differing hardness are present in a horizontal arrangement, providing a way to exactly establish different hardnesses in one molded article.

The polyurethane foams obtainable according to the invention are used, for example, for furniture cushioning, textile inserts, mattresses, automotive seats, headrests, armrests, sponges and component elements, and also seat and dashboard trim.

### EXAMPLES

### Raw Materials Used

polyol I-A1.1: propylene glycol-started polyether with propylene oxide alkylation and with an OH number of 56 mg KOH/g.
polyol I-A1.2: difunctional polyether polyol having an OH number of 57 mg KOH/g, prepared by KOH-catalyzed addition of propylene oxide and ethylene oxide in a weight ratio of 50:50 by use of propylene glycol as starter compound and with about 60 mol % of primary OH groups.
polyol I-A1.3: polyether polyol with an OH number of about 20 mg KOH/g, prepared by KOH-catalyzed addition of propylene oxide and ethylene oxide in a weight ratio of 80:20 by use of glycerol as starter compound and with about 85 mol % of primary OH groups and containing about 43 wt % of filler (copolymer essentially of styrene and acrylonitrile).
polyol I-A1.4: trimethylolpropane-started polyether with about 1 wt % of propylene oxide and 99 wt % of ethylene oxide and an OH number of 255 mg KOH/g and with more than 80 mol % of primary OH groups.
polyol II-A1.1: polyether polyol with an OH number of about 27 mg KOH/g, prepared by KOH-catalyzed addition of propylene oxide and ethylene oxide in a weight ratio of 85:15 by use of glycerol as starter compound and with about 85 mol % of primary OH groups.
polyol II-A1.2: polyether polyol with an OH number of about 37 mg KOH/g, prepared by KOH-catalyzed addition of propylene oxide and ethylene oxide in a weight ratio of 27:73 by use of glycerol as starter compound about 83 mol % of primary OH groups.
B-1: mixture containing 60 wt % of 4,4′-diphenylmethane diisocyanate, 19 wt % of 2,4′-diphenylmethane diisocyanate and 19 wt % of polyphenyl polymethylene polyisocyanate (“polynuclear MDI”) with an NCO content of 32.5 wt %.

Niax® L6164 as component A4 from Momentive Performance Materials Inc.,

Dabco® NE 1070 as component A4 from Air Products GmbH, DE

Dabcao® NE 300 as component A4 from Air Products GmbH, DE

Tegostab®B8734LF as component A4 from Evonik Industries AG, DE

Jeffcat® ZR50 as component A4 from Huntsman Corporation, US

The molar proportion of primary OH groups is determined using ¹H NMR spectroscopy (Bruker DPX 400, deuterochloroform):

To determine the content of primary OH groups, the polyol samples were first peracetylated.

This was done using the following peracetylation mixture:
9.4 g of acetic anhydride p.A.
1.6 g of acetic acid p.A.
100 mL of pyridine p.A.

For the peracetylation reaction, 10 g of polyetherpolyol were weighed into a 300 mL flanged Erlenmeyer flask. The volume of peracetylation mixture was guided by the OH number of the polyetherpolyol to be peracetylated, rounding the OH number of the polyetherpolyol up to the next multiple of 10 (based in each case on 10 g of polyetherpolyol); for every 10 mg KOH/g, 10 mL of peracetylation mixture are then added. For example, 50 mL of peracetylation mixture were correspondingly added to the sample of 10 g of a polyetherpolyol having an OH number=45.1 mg KOH/g.

After the addition of glass boiling chips, the flanged Erlenmeyer flask was provided with a riser tube (air condenser) and the sample was boiled under gentle reflux for 75 min. The sample mixture was then transferred into a 500 mL round-bottom flask, and volatile constituents (essentially pyridine, acetic acid and excess acetic anhydride) were distilled off at 80° C. and 10 mbar (absolute) over a period of 30 min. The distillation residue was then admixed three times with 100 mL each time of cyclohexane (toluene was used as an alternative in the cases in which the distillation residue did not dissolve in cyclohexane), and volatile constituents were removed each time at 80° C. and 400 mbar (absolute) for 15 min. Subsequently, volatile constituents of the sample were removed at 100° C. and 10 mbar (absolute) for one hour.

To determine the molar proportions of primary and secondary OH end groups in the polyether carbonate polyol, the sample thus prepared was dissolved in deuterated chloroform and analyzed by means of ¹H NMR (from Bruker, DPX 400, 400 MHz, zg30 pulse program, wait time d1: 10 s, 64 scans). The relevant resonances in the ¹H NMR (relative to TMS=0 ppm) are as follows:

Methyl signal of a peracetylated secondary OH end group: 2.04 ppm

Methyl signal of a peracetylated primary OH end group: 2.07 ppm

The molar proportion of secondary and primary OH end groups is then found as follows:

Proportion of secondary OH end groups

(CH—OH)=A(2.04)/(A(2.04)+A(2.07))*100% (I)

Proportion of primary OH end groups

(CH2-OH)=A(2.07)/(A(2.04)+A(2.07))*100% (II)

In the formulae (II) and (III), A represents the area of the resonance at 2.04 ppm or 2.07 ppm.

The isocyanate index (i.e., the index) indicates the ratio of the isocyanate quantity actually used to the stoichiometric, i.e., computed, quantity of isocyanate (NCO):

Isocyanate index=[(isocyanate quantity used):(isocyanate quantity computed)]*100 (III)

Apparent density was determined in accordance with DIN EN ISO 3386-1-98.

OH number was determined in accordance with DIN 53240.

Formulation I (Viscoelastic Formulation):

| | | |
|---|---|---|
| I-A1.1 | [parts] | 23.3 |
| I-A1.2 | [parts] | 46.6 |
| I-A1.3 | [parts] | 20 |
| I-A1.4 | [parts] | 10 |
| NIAX ® L-6164 (A4) | [parts] | 2 |
| WATER (A2) | [parts] | 1.45 |
| DABCO ® NE1070 (A4) | [parts] | 1.6 |
| B.1 | [parts] | 33.04 |

Formulation II:

| | | |
|---|---|---|
| II-A1.1 | [parts] | 97 |
| II-A1.2 | [parts] | 3.0 |
| diethanolamine (A3) | [parts] | 1.2 |
| Tegostab ® B8734 LF (A4) | [parts] | 0.9 |
| WATER (A2) | [parts] | 3.5 |
| JEFFCAT ® ZR50 (A4) | [parts] | 0.40 |
| DABCO ® NE300 (A4) | [parts] | 0.1 |
| B.1 | [parts] | 61.06 |

Production of Molded Flexible Polyurethane Foam Articles Having 3 Zones of Differing Hardness.

The starting components are processed in the one-shot process under the processing conditions customary for the production of molded flexible polyurethane foams.

Table 2 shows the isocyanate index for the processing stage (it determines the amount of polyisocyanate to be used relative to formulations I and II).

Formulation I is used for two point fillings (1^{st} and 2^{nd} point filling in FIG. 1) with 150 g shot

weight each at an index of 90. After a fiber time of 4 min, formulation II-1 is used in each case for two point fillings (point fillings 3 & 4 in FIG. 1) with 260 g shot weight each at an index of 110. The point fillings with formulation II-2 are followed by an importation as line filling (arrowed in the figure) with a shot weight of 600 g at an index from 85. After a further 5 min, the molding is demolded and crushed in a vacuum crusher to burst open its closed cells.

FIG. 1 shows an example of a mold cavity having regions separated by ridges.

The reproducibility of the horizontal layering was verified by DIN EN ISO 2439 indentation hardness determination on 20 foamed moldings in accordance with the method of production described above. The results are summarized in table 1.

TABLE 1
Indentation hardness determination with deviation from mean (Ø)

| molding | 1 | 2 | 3 | 4 | 5 | 6 | 7 |
|---|---|---|---|---|---|---|---|
| indentation hardness | 318.8 | 317.5 | 317.9 | 310.9 | 311.2 | 304.4 | 318.3 |
| [N] | | | | | | | |
| deviation from Ø¹ [%] | 5.5 | 5.0 | 5.2 | 2.8 | 3.0 | 0.7 | 5.3 |
| molding | 8 | 9 | 10 | 11 | 12 | 13 | 14 |
| indentation hardness | 308.5 | 318.9 | 291.2 | 285.8 | 306.3 | 293.6 | 289.8 |
| [N] | | | | | | | |
| deviation from Ø¹ [%] | 2.1 | 5.5 | −3.7 | −5.4 | 1.3 | −2.9 | −4.1 |
| molding | 15 | 16 | 17 | 18 | 19 | 20 | |
| indentation hardness | 285.0 | 299.2 | 291.9 | 296.3 | 294.1 | 285.9 | |
| [N] | | | | | | | |
| deviation from Ø¹ [%] | −5.7 | −1.0 | −3.4 | −2.0 | −2.7 | −5.4 | |

¹mean Ø = 302.3 N

The physical properties of the individual foam types (formulation I index 90, formulation II-1 index 110 and also formulation II-2 index 85) are reported in table 2. Foam density was determined in accordance with DIN EN ISO 845. Compression load deflection (CLD) 40% was determined in accordance with DIN EN ISO 3386-1-98 in the 4^{th} cycle at 40% compression. Tensile strength and elongation at break were determined in accordance with DIN EN ISO 1798. Compression set (CS 50%) was determined in accordance with DIN EN ISO 1856-2000 at 50% compression.

TABLE 2
Molded flexible polyurethane foams; properties

| | | Formula- | Formula- | Formula- |
|---|---|---|---|---|
| | | tion I | tion II-1 | tion II-2 |
| foam type | | visco- | HR | HR |
| | | elastic | | |
| index | | 90 | 110 | 85 |
| cell structure | | fine | fine | fine |
| apparent density | [kg/m³] | 83 | 55 | 54 |
| tensile strength | [kPa] | 90 | 247 | 150 |
| elongation at | [%] | 180 | 85 | 112 |
| break | | | | |
| CLD 40% | [kPa] | 2.7 | 9.6 | 4.3 |
| CS 50% | [%] | 11 | 4.9 | 5.6 |

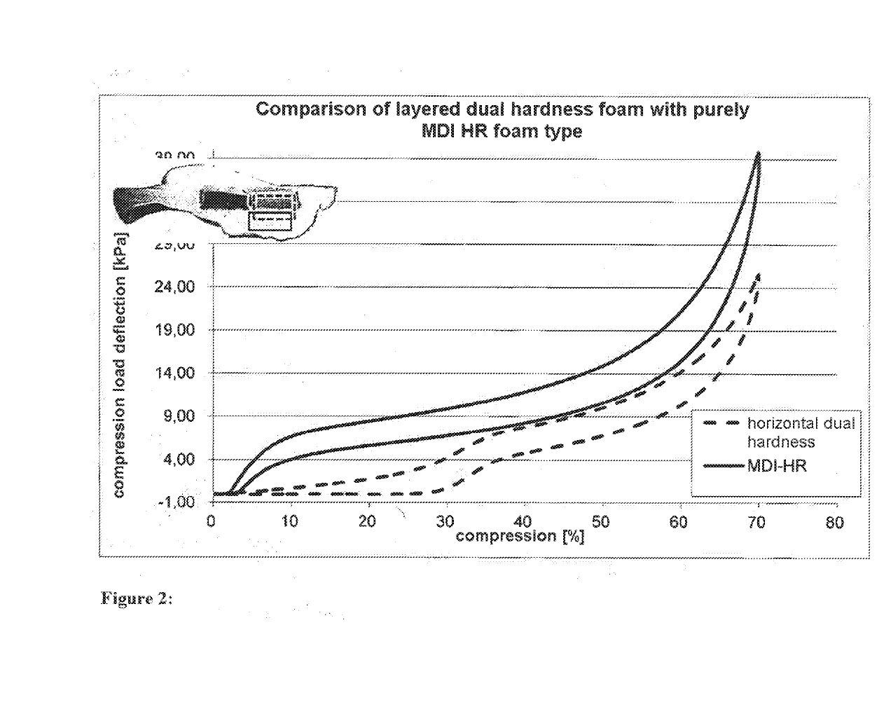

FIG. 2 shows the comparison of the different horizontally layered hardness regions in the foamed molding. The comparison in FIG. 2 is between the compression load deflection profiles of a purely MDI-HR foam type with the foam of the present invention, which has horizontally arranged region of differing hardness. The difference between a compression in the range from 0 to 40% is conspicuous. At between 0 to 30% compression, the curve resulting for the foam which is in accordance with the present invention is only due to the softer, viscoelastic foam (resulting from mixture I). At between 30% and 40%, both types of foam come into play. At a compression of 40% or more, it is essentially the MDI-HR foam (resulting from mixture II) which contributes to the hardness.

FIG. 3 shows a foamed article produced by the method of the present invention in seat shape. The dark regions represent the region of formula I, the lighter regions at the sides and in the front represent the regions of formula II. The sitting surface (dark) is arranged horizontally relative to the entire seat region.

1.-14. (canceled)

15. A method for producing molded flexible polyurethane (PU) foams having horizontally arranged zones of differing hardness, comprising in step
1) importing and free-foaming a flowable reaction mixture I into the mold cavity,
2) from 1 to 6 min after importing said reaction mixture I into the mold cavity, importing at least one flowable reaction mixture II into the mold cavity,
3) curing in the mold, and
4) demolding the molded flexible PU foam formed after step 3,
wherein said flowable reaction mixture I forms a flexible PU foam having an apparent density of 30 to 90 kg/m³ and said flexible reaction mixture II forms a molded flexible PU foam having an apparent density of 30 to 85 kg/m³.

16. The method as claimed in claim 15, wherein the reaction mixture I in step 1 comprises component I-A1 comprising
I-A1.1 at least one polyether polyol having a functionality of 2 to 8, a DIN 53240 hydroxyl (OH) number in the range from 20 to 70 mg KOH/g and a polyoxypropylene (PO) content in the range from 50 to 100 wt % and a polyoxyethylene (EO) content in the range from 0 to 50 wt %,
I-A1.2 optionally at least one polyether polyol having a hydroxyl functionality of 2 to 8, a DIN 53240 OH number in the range from 50 to 65 mg KOH/g and a PO content in the range 45 to 55 wt/o % and an EO content in the range from 45 to 55 wt %;
I-A1.3. optionally at least one dispersion of a polymer in a polyether polyol, wherein the dispersion has a DIN 53240 OH number in the range from 10 to 30 mg KOH/g and wherein the polyether polyol has a hydroxyl functionality of 2 to 6, a PO content in the range from 70 to 90 wt % and an EO content in the range from 10 to 30 wt %;
I-A1.4 optionally at least one polyether polyol having a functionality of 2 to 8, an OH number in the range from 220 to 290 mg KOH/g and a PO content of up to 25 wt % and an EO content of at least 75 wt %;
A2 water and/or a physical blowing agent,
A3 optionally isocyanate-reactive hydrogen compounds having an OH number of 140 mg KOH/g to 900 mg KOH/g,
A4 auxiliary and added-substance materials such as
a) catalysts,
b) surface-active added-substance materials, and
c) pigments or flame retardants, and
B di- and/or polyisocyanates,
wherein the foam is produced at an isocyanate index of 70 to 130.

17. The method as claimed in claim 15, wherein said reaction mixture I contains component I-A1.1 in an amount of 10 to 100 parts by weight; component I-A1.2 in an amount of 0 to 70 parts by weight; component I-A1.3 in an amount of 0 to 40 parts by weight; component I-A1.4 in an amount of 0 to 25 parts by weight; component A2 in an amount of 0.5 to 25 parts by weight; component A3 in an amount of 0 to 10 parts by weight; component A4 in an amount of 0.05 to 10 parts by weight, wherein the proportional parts by mass of components I-A1.1 to I-A1.4 add up to 100 and wherein the parts by weight of components A2 to A4 are based on total component I-A1.

18. The method as claimed in claim 15, wherein said reaction mixture I contains component I-A1.1 in an amount of 10 to 40 parts by weight, component I-A1.2 in an amount of 30 to 70 parts by weight, component I-A1.3 in an amount of 5 to 40 parts by weight and component I-A1.4 in an amount of 5 to 25 parts by weight, component A2 in an amount of 0.5 to 25 parts by weight; component A3 in an amount of 0 to 10 parts by weight; component A4 in an amount of 0.05 to 10 parts by weight, wherein the proportional parts by mass of components I-A1.1 to I-A1.4 add up to 100 and wherein the parts by weight of components A2 to A4 are based on total component I-A1.

19. The method as claimed in claim 15, wherein the reaction mixture II in step 2 comprises component II-A1 comprising
II-A1.1 at least one polyether polyol having a functionality of 2 to 8, a polyoxyethylene (EO) content of 0 to 30 wt %, a DIN 53240 OH number of ≧10 mg KOH/g to ≦112 mg KOH/g,
II-A1.2 optionally at least one polyether polyol having a functionality of 2 to 8, a polyoxyethylene (EO) content of >60 wt %, a DIN 53240 OH number of ≧10 mg KOH/g to ≦112 mg KOH/g,
II-A1.3 optionally at least one dispersion of a polymer in a polyether polyol, wherein the dispersion has a DIN 53240 OH number in the range from 10 to 60 mg KOH/g and wherein the polyether polyol has a hydroxyl functionality of 2 to 6, a polyoxypropylene (PO) content in the range from 70 to 90 wt % and an EO content in the range from 10 to 30 wt %;
A2 water and/or physical blowing agents,
A3 optionally isocyanate-reactive hydrogen compounds having an OH number of 140 mg KOH/g to 900 mg KOH/g,
A4 auxiliary and added-substance materials such as
a) catalysts,
b) surface-active added-substance materials, and
c) pigments or flame retardants, and
B di- or polyisocyanates,
wherein the flexible polyurethane foam is produced at an isocyanate index of 75 to 120.

20. The method as claimed in claim 19 comprising component II-A1.1 in an amount of 10 to 100 parts by weight; component II-A1.2 in an amount of 0 to 10 parts by weight and component II-A1.3 in an amount of 0 to 90 parts by weight; component A2 in an amount of 0.5 to 25 parts by weight; component A3 in an amount of 0 to 10 parts by weight; component A4 in an amount of 0.05 to 10 parts by weight, wherein the parts by weight of II-A1.1 to II-A1.3 add up to 100 and wherein the parts by weight of components A2 to A4 are based on total component II-A1.

21. The method as claimed in claim 15, wherein a plurality of reaction mixtures II are imported in succession into the mold cavity in step 2, wherein these reaction mixtures II differ in the DIN EN ISO 3386-1-98 compression load deflection of the flexible PU foam these reaction mixtures II produce and wherein at least one of these reaction mixtures II is in a horizontal arrangement relative to the flexible PU free-foamed in step 1).

22. The method as claimed in claim 15, wherein, in step 2, the flowable reaction mixture II comprises flowable reaction mixtures II.1 and II.2, wherein said flowable reaction mixtures II.1 and II.2 have the same composition and wherein said flowable reaction mixture 1.1 is produced at an isocyanate index of 95 to 120 and said flowable reaction mixture II.2 is produced at an isocyanate index of 75 to 95.

23. The method as claimed in claim 16, wherein component B contains one or more aromatic polyisocyanates.

24. The method as claimed in claim 15, wherein said flowable reaction mixture I contains by way of component B at least one compound selected from the group consisting of 4,4′-, 2,4′- and 2,2′-diphenylmethane diisocyanate and polyphenyl polymethylene polyisocyanate (“polynuclear MDI”), and mixtures thereof.

25. The method as claimed in claim 15, wherein said flowable reaction mixture I gives rise to a viscoelastic foam having a DIN EN ISO 3386-1-98 compression load deflection of 2.0 to 4.0 kPa.

26. A molded flexible polyurethane foam obtained by the method as claimed in claim 15.

27. A flexible polyurethane molding obtained by the method as claimed in claim 15.

28. A method comprising utilizing the flexible polyurethane molding as claimed in claim 27 in the manufacture of furniture cushioning, textile inserts, mattresses, automotive seats and headrests.
